(19) United States
(12) Patent Application Publication
(10) Pub. No.: US 2004/0091173 A1
(43) Pub. Date: May 13, 2004

(54) Method, apparatus and system for the spatial interpolation of color images and video sequences in real time

(76) Inventors: Hiroshi Akimoto, Kawasaki-shi (JP); Alla S. Yeroshchenko, Kawasaki-shi (JP)

Correspondence Address: David L. Garrison, Garrison & Associates PS, Suite 3300, 2001 Sixth Avenue, Seattle, WA, 98121-2522, US

(21) Appl. No.: 10/622,297

(22) Filed: Jul. 17, 2003

Related U.S. Application Data
(60) Provisional application No. 60/397,055, filed on Jul. 17, 2002.

(51) Int. Cl. G06K 9/32; G06K 9/40

(52) U.S. Cl. 382/300; 382/260

(57) ABSTRACT

The current invention discloses a system for the construction of band-pass filters, used for the alteration of the dimensions of half-tone images. The method may be used for the spatial interpolation of a video sequence and a single image. The method works equally well for different classes of images of high-quality scaled images that do. In the resulting images a gradual effect on the contours or other defects associated with previous methods is absent. The method includes two algorithms. The first permits the lengthwise and/or width-wise enlargement of the image an even number of times. The second permits the reduction of the image by a fraction. The given method provides good quality when scaling of a video sequence in real time.

### CROSS REFERENCE TO RELATED APPLICATION

This application claims the benefit of U.S. Provisional Patent Application No. 60/397/055, filed Jul. 17, 2002, entitled “Method, Apparatus and System for Color Image and Video Sequence Spatial Interpolation in Real Time.

### FIELD OF INVENTION

The current invention relates to the realm of video and static image processing, and more particularly to the spatial interpolation of pixels as applied to a video sequence or an initial static image. The video sequence may be an original as well as a sequence restored after video compression by any method.

### BACKGROUND OF THE INVENTION

There are two principally different approaches to the description of the images. The image may be described with the help of graphic primitives that form the image. We call such an image a vector image. If the image is described by a two-dimensional array, each element of which constitutes the description of a color, then such an image is called half tone. An element of the half-tone image is called a pixel. Thus, the half-tone image may represent a two-dimensional array of data, representing points of different colors. The size of the array is determined by the number of lines r and columns c.

There are several types of half-tone images. They are distinguished from each other by means of the presentation and storage in memory of information about the color or the brightness of the pixel. The color is formed as a result of the mixing of several color components, which may be assigned to several color spaces.

The concept of depth of color is used to designate the number of bits needed for the storage of information about the color of the pixel. The depth of color is measured in bits per pixel. In calculating the depth of color (d), the image may be presented as a three-dimensional array of data, requiring large memory resources for storage. The quantity of memory in bytes necessary for the storage of a half-tone image may be calculated according to the formula:

$$V = \frac{c \cdot r \cdot d}{8} ,$$

where c is the number of columns, r is the number of lines, d is the depth of color. The following types of images are distinguished:

Binary—their pixels adopt only two values −0 and 1, which designate, respectively, the colors black and white.

Gray-scale—their pixels adopt one of the values of intensity of some one color (usually gray in the range from black to white).

Palette—their pixels are references to the cell of the palette containing descriptions of the color of the pixel in some color system. At this time, for the description of the colors of digital images, the RGB color system is more frequently used, in which the columns of the palette represent the intensity of the red, green and blue components.

Full color—their pixels store information about the intensity of color components. These images store complete information about the color, but require a large amount of memory. The number of bits allocated for the storage of each of the color components may be variable. This amount is called the number of bits per channel. The depth of color is equal to the sum of bits per channel for each of the components. For the RGB color system, the most prevalent are full-color images with a color depth of 16 and 24 bits/pixel. In the given invention the processing of the image is carried out as applied to images in the RGB color system with a color depth of 24 bits.

With the exception of the proposed approach to the description of the types of images, proceeding from their representation in the computer's memory it is possible to separate classes of images, taking into consideration the information contained in the picture.

Thus, images or video sequences reflecting real activity are called realistic. These include videos, photographs etc. As a rule, realistic images contain many colors, since they transmit a picture from the real world. For example, the picture in FIG. 2a is realistic, since it is a photograph, while the image in FIG. 2b is not realistic.

Pictures with a small number of colors (4-16) and large regions executed in one color constitute yet another class of images. Gradual color transitions are absent. Examples: a business graphic—histograms, diagrams, graphics or cartoons (FIG. 2b).

Images with gradual color transitions, constructed on the computer. Example: presentation graphics.

### SUMMARY OF THE INVENTION

The current invention discloses a method for spatial interpolation of images when the images are enlarged or reduced. The current invention teaches the construction of band-pass filters for altering the dimensions of half tone images as a mathematical device for spatial interpolation. The disclosure in this application includes one mathematical algorithm for enlarging an image by an even number of times and another algorithm for reducing an image by a fraction.

Interpolated image quality is controlled by the order of power of the mathematical equation in the algorithm. For example, a bi-cubic algorithm using third and higher order polynomials will produce an interpolated image that has better quality than a bilinear algorithm using a first order polynomial.

The method that is the subject of the current invention was tested on different classes of images. Good results were obtained for different types of pictures and video sequences. Thus, FIGS. 5, 6 and 7 illustrate the translation of frames of real video sequences from the QCIF format to the SIF format. The method, applied during such scaling, is described in detail below.

### BRIEF DESCRIPTION OF THE DRAWINGS

FIG. 1 illustrates the construction of a curve through the given points.

FIGS. 2a and 2b shows a comparison of the “nearest neighbor” method and the method described herein, where drawing 2a a realistic image is shown, in drawing 2b an unrealistic image with a small number of colors is shown.

FIG. 3 illustrates the algorithm for the spatial interpolation of the image.

FIG. 4 illustrates in detail an example of the work of the method for reducing the original illustration by a fraction.

FIGS. 5, 6 and 7 illustrate a method for the scaling of the frames of a video sequence from QCIF format to SIF format.

### DETAILED DESCRIPTION OF THE INVENTION

According to the teachings of the current invention, the method disclosed herein permits one to change the dimensions of the image at high speed, when working with both a solitary image and with a video sequence. During processing of the video sequence, high speed is attained, with a different scaling of video (for example, from the SIF format to the BT format, or from the QCIF format to the SIF format).

At this time, there are several prevalent approaches to the spatial interpolation of an image, for example the “nearest neighbor” method.

During the change of the dimensions of the initial image, values adjacent to the current pixels are selected as the new pixels. During enlargement of an image the values of the new, added pixels will be repeated, and during reduction, several pixels are omitted. For example, during scaling of 1.3:1 of an image, that is, a reduction by 30%, the following picture is obtained:

| | | |
|---|---|---|
| Pixel 0 | pixel 1 | pixel 2 |
| position 0 | position 1 | position 2 |

First pixel 0 (located in position 0) is taken, then the pixel is sought that is closest to position 1.3—this will be pixel 1, further we seek the pixel closest to position 2.6—this will be pixel 3. Thus, pixel 2 turns out to be omitted. Because of this, a gradation is found on the resulting image.

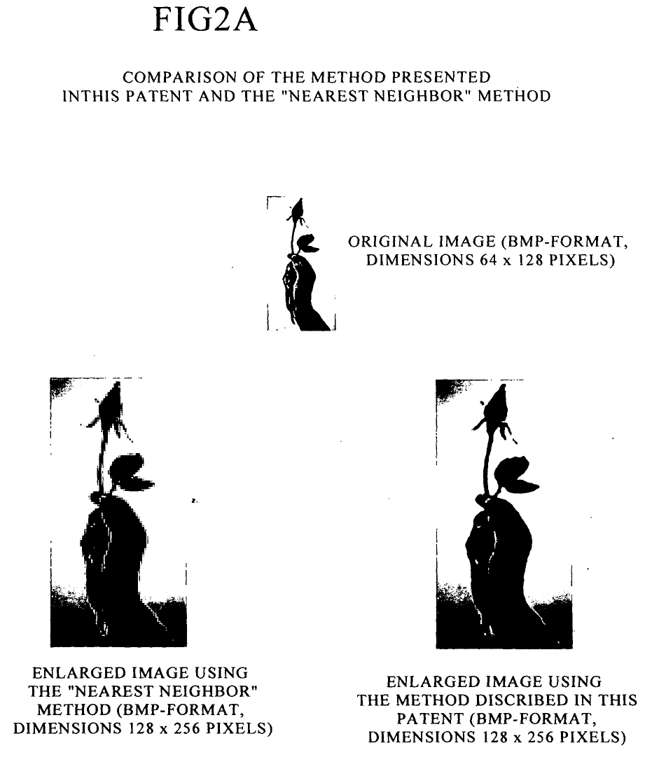

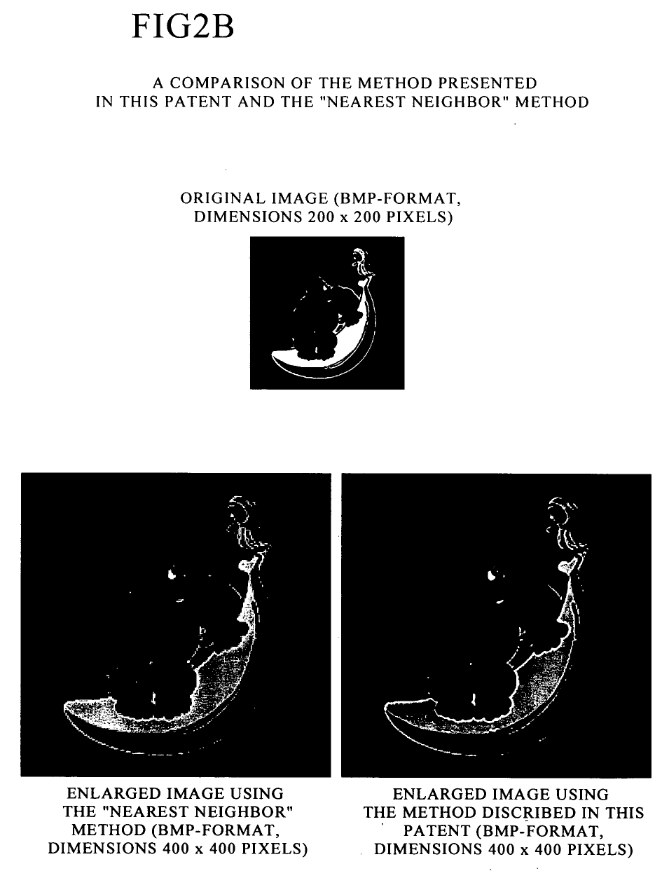

The method disclosed herein allows one to avoid the inadequacies characteristic to many rapid methods, due to the selection of an interpolation function. Examples of pictures enlarged by the “nearest neighbor” method and the method that is the subject of this patent are shown in FIGS. 2a and 2b.

The problem of scaling images may be examined in terms of the approximating of functions. In general the approximation is connected with the interpolation of functions. The goal of approximation consists of finding the values of a function at any selected points, whereas during interpolation there is already a selection of assigned points, through which this function must pass.

Let (x₀, y₀), (x₁, y₀), . . . , (x_{N}, y_{N}) be a sequence of points assigned on a plane and constituting the initial selection of data. xᵢ—is an image pixel, yᵢ is its corresponding brightness value and yᵢ=f(xᵢ). It is necessary to repeat the function f(x) for other x≠xᵢ (i=0, 1, . . . , N).

The classic approach to the solution of such a problem lies in the fact that, using the information we possess about the function f(x), in order to examine another function φ that is near in some sense to f and that permits one to execute an appropriate operation on it and to obtain a value of the error for such a “substitution.” In the process of the digital implementation of this approach it is necessary to examine a number of questions:

The first question is a question about the available information relative to the function f. According to the teachings of the current invention, it is not important in which format the input image that comprises the initial set of data is examined. The image may be presented in any known color system (for example, RGB or YUV).

The second question is a question about the class of the approximating function; that is, as to by what functions φ the function f will be approximated. Here it is necessary to be guided by two main factors that are important for the given method disclosed herein. First of all, the approximating function should express the characteristic features of the approximated function, and secondly, it should be sufficiently convenient for programming implementation, that is, more than anything it should not require a large amount of calculations.

In the numerical analysis, three groups of approximating functions have wide application.

The first—are polynomials of different powers of the type 1, x, . . . , xⁿ.

The second—are the trigonometric functions sin aᵢx and cos aᵢx.

The third group consists of the exponential functions e^{a}_{ᵢ}^{x}.

For the methods disclosed herein, functions of the first type are used for the spatial interpolation of an image. According to the formula it is possible to construct a Lagrange interpolation polynomial of degree N−1 along N points y₁=f(x₁), y₂=f(x₂), y₃=f(x₃), y_{N}=f(x_{N}). The interpolation polynomial is described in the explicit form of the classic Lagrange formula:

$$P ( x ) = \frac{( x - {x}_{2} ) ( x - {x}_{3} ) … ( x - {x}_{N} )}{( {x}_{1} - {x}_{2} ) ( {x}_{1} - {x}_{3} ) … ( {x}_{1} - {x}_{N} )} {y}_{1} + \frac{( x - {x}_{1} ) ( x - {x}_{3} ) … ( x - {x}_{N} )}{( {x}_{2} - {x}_{1} ) ( {x}_{2} - {x}_{3} ) … ( {x}_{2} - {x}_{N} )} {y}_{2} + … + \frac{( x - {x}_{1} ) ( x - {x}_{2} ) … ( x - {x}_{N - 1} )}{( {x}_{N} - {x}_{1} ) ( {x}_{N} - {x}_{2} ) … ( {x}_{N} - {x}_{N - 1} )} {y}_{N}$$

In general algorithms used most frequently for the spatial interpolation of images may be provisionally divided into three classes:

The first class are algorithms for interpolation by the “nearest neighbor” method; here a polynomial of zero order is used;

The second class are bilinear algorithms; in them, a first-order polynomial is used;

The third class are bi-cubic algorithms; in them, third- and higher-order polynomials are used.

The choice of method for spatial interpolation depends on the required precision of approximation, because the precision of the location of the new pixels in the image during scaling depends on the degree of the interpolation polynomial. The higher the degree of the polynomial, the greater the quantity of points that take part in the approximation, and the more precise it will be.

The third question is the question of the closeness of the approximating and approximated functions, that is, the question of the choice of criterion for evaluation of the quality of the approximation, which the function φ must satisfy. This question lies in the fact that the determination of the “distance” or difference between the approximated and the approximating functions and the choice from the approximating functions of that function for which this distance is minimal. As was stated above, the precision of the location of the new pixels depends on the degree of the polynomial; the higher the degree, the greater the precision and the nearer the corresponding approximating function is to the approximated function. However, it is necessary to consider the growing complexity of the calculations when the degree of the polynomial is raised.

For problems of scaling images, the construction of an approximating function φ(x), congruent with nodes xᵢ with values of the given function, y=f (x), that is, such that φ(xᵢ)=yᵢ. Such an approximation method is called an interpolation. If the variable x, for which an approximate value for the function is determined, belongs to the interval [x₀, x_{N}], then the problem of determining the value of the function at point x is an interpolation. If the variable x is located outside the interval [x₀, x_{N}], then the problem posed is called an extrapolation. The problem of extrapolation is not the subject of the current invention, therefore it will not be described.

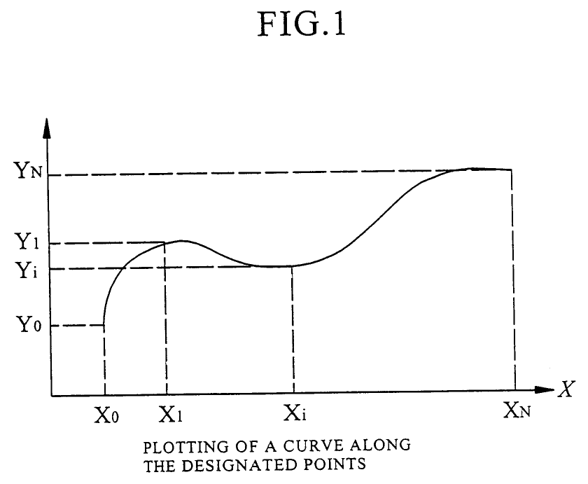

Geometrically, the problem of interpolation for the function y=f(x) implies the construction on the x, y plane of a curve, passing through points with the coordinates (x₀, y₀), (x₁, y₁), . . . (x_{N}, y_{N}). FIG. 1 illustrates the construction of the curve through the aggregate of given points.

The filter used for the spatial interpolation of the image is an important aspect of the current invention. Usually, during filtration of images the concept of a filter mask, which constitutes a selection of numbers and which may be univariate or bivariate, is used. The central element of the mask is the element located in the middle of the mask, that is the element with the coordinates:

$$( \frac{m + 1}{2} , \frac{n + 1}{2} ) ,$$

where m is the number of columns in a bivariate mask, and n is the number of lines.

For implementation of the filtration, the mask is placed upon the processed image and the pixel falling on the central element of the mask is formed by means of some processing of the values of pixels of the original image located underneath the mask. The mask moves along the original image, in order that its central element coincides with all of the image's pixels. However, with spatial interpolation of an image it is necessary not to process an already existing pixel, but rather to add a new pixel, changing the original image by the same dimension. Therefore, the value of the central coefficient is not known. Here a mathematical device for calculating the value of the polynomial at a given point is also necessary. The remaining coefficients of the filtering mask also are calculated with the help of polynomials.

Experimentation using the current invention has yielded a number of filters of differing lengths. As was shown above, the longer the filter, the higher the precision of the approximation. However, the length of the filter substantially influences the speed of work of the algorithm for the spatial interpolation of the image. Here one must make a choice between the speed of work of the algorithm and the quality of the obtained image. Testing showed that the optimal filter, from “speed-quality” point of view, which possessed such a mask was:

[−1 5 * 5 −1],

where * is the unknown coefficient.

One also may examine one of the longer filters, which gives a better approximation:

[−2 16 −49 163 * 163 −49 16 −2],

where * is the unknown coefficient.

The sum of the filter coefficients is equal to the number that is a degree of two. During processing of the image the filter coefficients are normalized to this number. Thus, the filter [−1 5 * 5 −1] is normalized to 8(2³), the filter [−2 16 −49 163 * 163 −49 16 −2] is normalized to 256(2⁸).

Here it is necessary to note that the obtained values must be located in the range from minimal color value to maximal color value. In the RGB and YUV color systems the value of each component is recorded in one byte, therefore one may accept values from 0 to 255. In order that the obtained values do not exceed the interval limits [0,255], a verification of the calculated values is made. If a value is greater than 255, it is made equal to 255, and if the value is less than 0, then it is set equal to 0.

The computation of the filters may continue. Filters were computed with 10, 12, 14 and more coefficients, however due to the computational complexity that grows together with the number of coefficients, they are not examined using the method disclosed herein. Thus, according to the teachings of the current invention, the method spatial interpolation is executed using the following steps:

Step 1: An initial image in the color system RGB or YUV is read. An important aspect of the method is the possibility that a single image in bmp-format as well as a video sequence can be read and presented as one file in, for example, avi format. If the video sequence is processed, then it is read and interpolated frame by frame. Thus, the video sequence constitutes a set of separate image-frames. As a rule, the dimensions of the frames depend on the format of the video sequence—the SIF format has a frame dimension of 352×240 pixels, QCIF—176×144, BT—704×480.

The method disclosed herein allows processing of initial images or video sequences in any known color system. The processing takes place separately for each of the color components (i.e., if an image in RGB format is processed, then the interpolation algorithm is executed for the R, G and B components separately).

However, it is more convenient to use the YUV system in connection with its characteristic features. In the YUV system, the Y component contains information about the brightness of the image pixels, while the U and V components contain information about their chromaticity. U is the difference between the intensities of the red and green colors, while V is the difference between blue and green. For the spatial interpolation of an image it is much more convenient to use the YUV system on the strength of the great information content of the Y component and the significantly lower information content of the remaining components. The algorithm is executed for Y while for U and V a lower-order filter is applied.

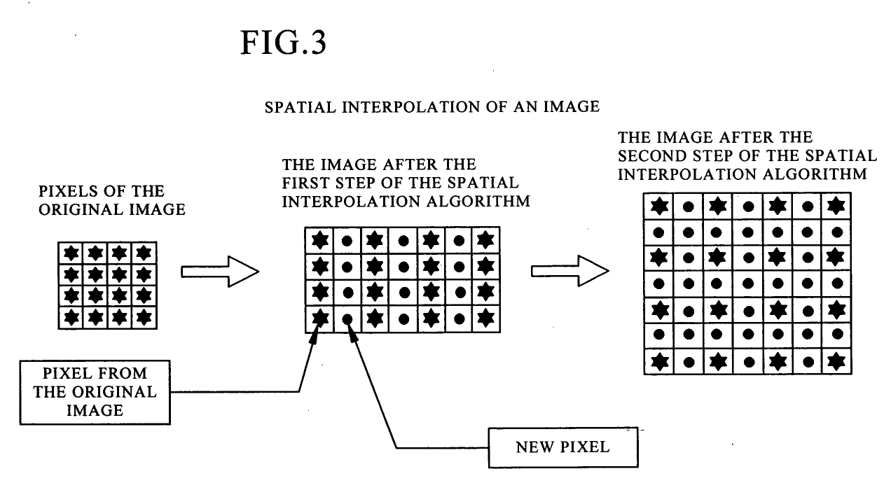

Step 2: Filtration of the image is subsequently carried out using the filters described above. The interpolation process is shown in FIG. 3.

Step 3: If it is necessary to reduce the image's height or width in the proportion q₁: q₂, where q>q, and q₁ and q₂ are natural numbers, then the method described below is applied.

Given the initial image I and the scaled image I*, it is necessary to translate the q₁ pixels from I into the q₂ pixels of the image I*. The current method is based on the calculation of the percentage portion of the area of the pixels of image I, that correspond with a pixel of the image I*. For the implementation of such a transformation a filter is calculated which element by element translates q₁ of the pixels of the initial image I into the q₂ pixels of the scaled image I*.

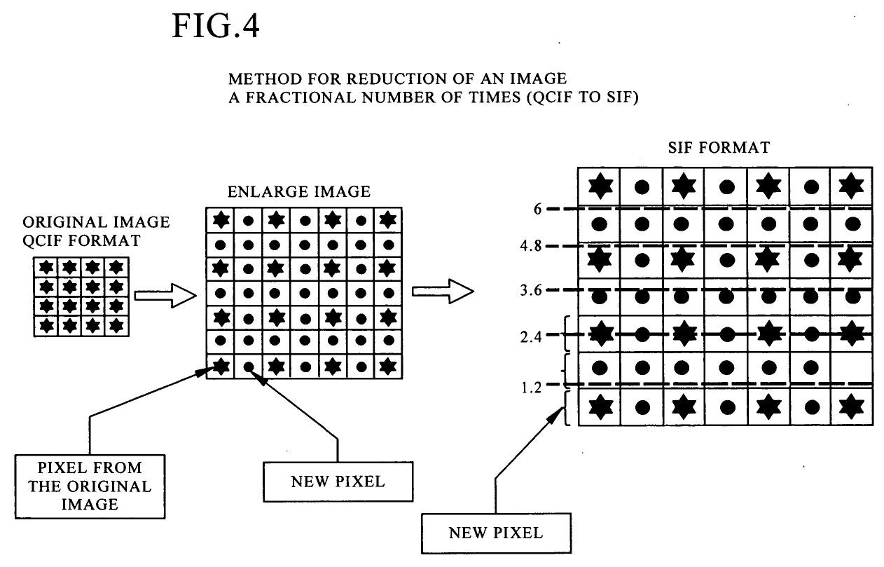

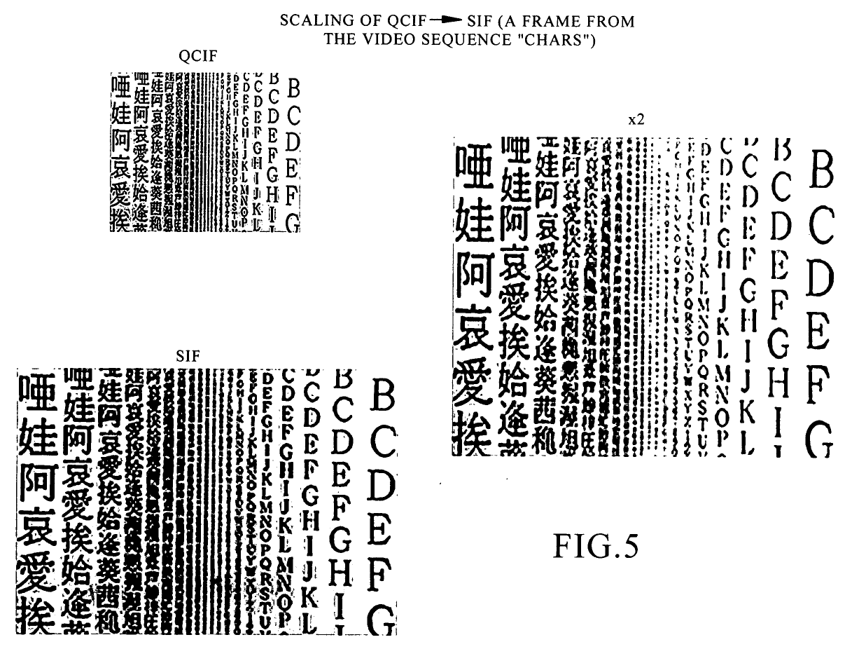

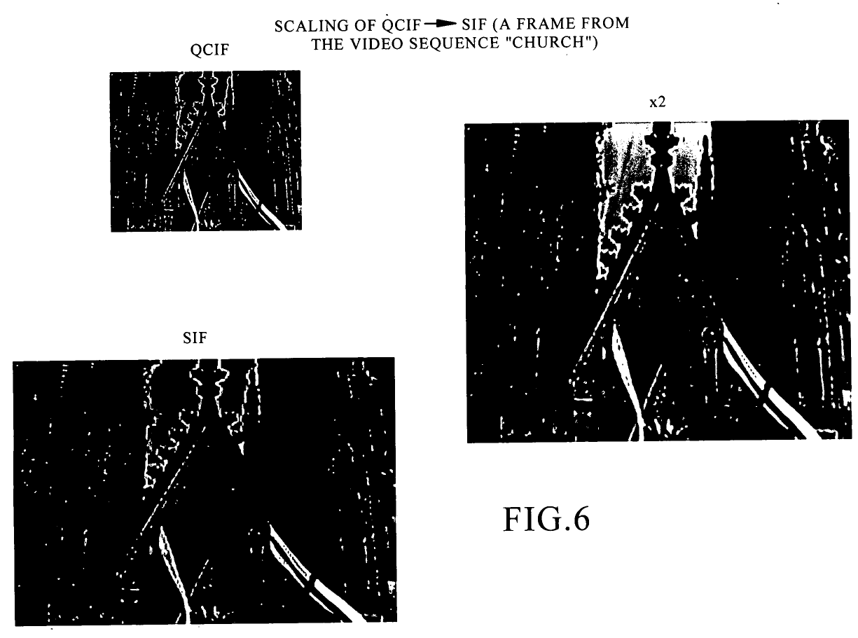

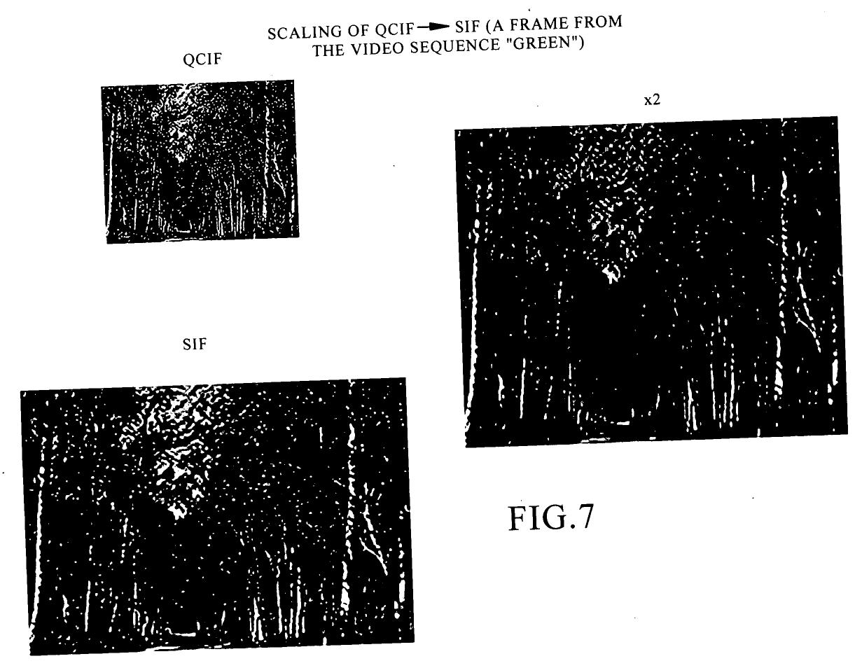

For example, during scaling of the video sequence it was necessary to implement the translation of images from the QCIF format (176×144 pixels) into the SIF format (352×240 pixels). (See FIG. 4.)

The initial image is first translated into an image two times larger than the original in both width and height, using the filter

[−1 5 * 5 −1].

Subsequently it is necessary to reduce the image in the ratio 6:5 (that is 288:240).

Upon calculation of the filter the following weighted coefficients were obtained:

[0.8333 0.1667 0.6667 0.3333 0.5 0.5 0.3333 0.6667 0.1667 0.8333]

The given filter, possessing a length of 10, translates 6 pixels from the image two by two into 5 pixels for the image I*.

According to the teachings of the current invention, it is important to use an algorithm possessing a high speed of work during scaling of the video sequence. In order to avoid operations with a floating point and a division operation, significantly slowing the work of the algorithm, the following approach is implemented:

The filter coefficients are increased to a number that is a sufficiently large power of two. The higher the power of two, the more precise filter coefficients will be obtained. In the example, the filter coefficients increase to 256(2⁸). For the values of coefficients after the increase a whole part is selected. The following coefficients are obtained:

[213 43 171 85 128 128 85 171 43 213]

The corresponding coefficients to the values of brightness of the pixels are increased and normed to 256(2⁸). In order to implement the translation from six pixels to five, it is necessary to put them together two by two, weighing them on the corresponding filter coefficients, as indicated in the equations below:

a₁ₘ*=(213a₁+43a₂)/256;

a₂ₘ*=(171a₂+85a₃)/256;

a₃m^{*=(}128a₃+128a₄)/256;

a₄ₘ*=(85a₄+171a₅)/256;

a₅ₘ*=(43a₅+213a₆)/256;

where m is the number for the column I of the image, aᵢₘ is the pixel for the initial image I, a*ᵢₘ is the pixel for the new image I*.

This invention describes a method and device for the spatial interpolation of static images and video sequences. The proposed method works quickly due to the absence of operations with a floating point, which would significantly slow the work of the algorithm during the processing of images or video. Moreover, the given method permits one to avoid the deficiencies present with other interpolation methods, such as gradation, fuzzy contours and indistinct objects. In such a way, the method for spatial interpolation of images proposed in this patent permits one to obtain a high visual quality for the output images or video sequences.

### INDUSTRIAL APPLICABILITY

The current invention discloses methods and procedures for spatial interpolation of color images and video sequences in real time. The methods and procedures disclosed in the current application can be executed or preformed in a computer, other microprocessors, programmable electronic devices or other electronic circuitry that are used for encoding video film. They can be loaded into the above devices as software, hardware, or firmware. They can be implemented and programmed as discrete operations or as a part of a larger image processing strategy.

In compliance with the statute, the invention has been described in language more or less specific as to structural features. It is to be understood, however, that the invention is not limited to the specific features shown or described, since the means and construction shown or described comprise preferred forms of putting the invention into effect. Additionally, while this invention is described in terms of being used to provide a method of spatial interpolation of color images in real time, it will be readily apparent to those skilled in the art that the invention can be adapted to other uses as well. The invention should not be construed as being limited to spatial interpolation and is therefore, claimed in any of its forms or modifications within the legitimate and valid scope of the appended claims, appropriately interpreted in accordance with the doctrine of equivalents.

What is claimed is:

1. A method for enlarging still images or single video frames in an electronic media comprising the steps of:
a. selecting an image for enlargement;
b. selecting a filtering algorithm from a pre-determined library of algorithms based on the desired quality of the enlarged image;
c. selecting a filter coefficients from a pre-determined library of filter coefficients based on the desired quality of the enlarged image and the speed of operation of the algorithm;
d. constructing a filter mask for determining the value of the pixels to be added for enlarging the image;
e. executing the filter algorithm on the horizontal rows of the image at each point where a pixel is to be added to determine the value of the pixel to be added; and
f. executing the filter algorithm on the vertical columns of the image at each point where a pixel is to be added to determine the value of the pixel to be added.

2. A method for reducing the size of still images or single video frames in an electronic media comprising the steps of:
a. selecting an image for reduction;
b. selecting a filtering algorithm for enlarging the video from a pre-determined library of algorithms based on the desired quality of the reduced image;
c. constructing a filter mask using pre-designated filter coefficients for determining the value of the pixels to be added for enlarging the image;
d. enlarging the image to twice its original size by executing the filter algorithm on the horizontal rows of the image at each point where a pixel is to be added to determine the value of the pixel to be added and executing the filter algorithm on the vertical columns of the image at each point where a pixel is to be added to determine the value of the pixel to be added;
a. determining the level of reduction desired;
b. selecting filter coefficients based on the level of reduction desired;
c. increasing the value of the filter coefficients based on the desired speed of the reduction; and
d. executing a pre-designated reduction filtering algorithm using the filter coefficients to translate the pixels two by two from the enlarged image into the number of pixels required for the desired level of reduction in the reduced image.

3. A new method for the scaling of images with the help of a polynomial interpolation, which includes:
a. a method for the scaling of images as a whole an even number of times by width and length (by two dimensions) or by one dimension;
b. a rapid method for the scaling (reduction) of an image by a fraction of a number by any one of its dimensions.

4. A method for the scaling of a video sequence, including the following aspects:
a. the input video sequence may be in any known video format (for example SIF, QCIF);
b. the input sequence of images is presented as one file, for example, as a videofilm;
c. processing of the video sequence takes place frame-by-frame;
d. the given method may be used for the processing of a regenerated video sequence after compression by any sort of coding method;
e. the output video sequence also constitutes one file;

5. A system developed for the uniform scaling of color images of different sizes; the given system permits:
a. an increase in the dimensions of the input image horizontally;
b. an increase in the dimensions of the input image vertically;
c. a change in the dimensions of the input image both horizontally and vertically, preserving the proportions of the original image;
d. a reduction of the image by a fraction vertically;
e. a reduction of the image by a fraction horizontally; and
f. a reduction of the image by a fraction both vertically and horizontally.
